(19) United States
(12) Patent Application Publication
(10) Pub. No.: US 2023/0219708 A1
(43) Pub. Date: Jul. 13, 2023

(54) Product Unpackaging System

(71) Applicant: Custom Technologies LLC, Brentwood, MO (US)

(72) Inventor: Dennis Todd Mell, Farmington, MO (US)

(73) Assignee: Custom Technologies LLC, Brentwood, MO (US)

(21) Appl. No.: 17/988,058

(22) Filed: Nov. 16, 2022

Related U.S. Application Data
(60) Provisional application No. 63/281,199, filed on Nov. 19, 2021.

(51) Int. Cl. B65B 69/00

(52) U.S. Cl. CPC B65B 69/0033; B23K 26/38

(57) ABSTRACT

The present invention describes an automated product unpackaging system that manipulates a target container containing product into an unpackaging work cell area, moves the target container into and through a desired path within the work cell in such a way that lasers or other industrial cutters can cut through the original packaging material so that the package's bottom surface is completely separated from the top and sides of the original package, and then moves the top and sides of the original package, with its product still encapsulated inside, slidingly onward toward a next operation. The invention also describes means for extraction and disposal of the top and sides of the original package, along with the separated bottom of the original package.

### CROSS REFERENCE TO RELATED APPLICATION

Not applicable.

### STATEMENT REGARDING FEDERALLY SPONSORED RESEARCH OR DEVELOPMENT

Not applicable.

### SEQUENCE LISTING, TABLE OR COMPUTER PROGRAM ON COMPACT DISC

Not applicable.

### FIELD OF INVENTION

The present disclosure relates generally to the field of automation machinery relating to packaging and product handling, and more specifically to the field of automation machinery for the unpackaging of products packaged within boxes or other generally flat-bottomed containers.

### BACKGROUND OF THE INVENTION

This section provides background information related to the present disclosure which is not necessarily prior art.

Various automation machinery related to industrial packaging are well established in modern industry, and within the subset of machinery related to handling box-shaped packages, commercially-available machines are regularly used in myriad industries to enable such general processes as box erection, box sealing, box filling with a desired product, box transfer, and other related packaging tasks.

In addition to such aforementioned common packaging tasks, it is often also desirable to extract various products from their boxes or other flat-bottomed packaging in an automated manner. For example, a sub-industry exists within the packaging industry which is known as ‘repackaging’. Repackaging can be required in a diversity of commercial applications. For example, it is common in modern economies for manufacturers in various industries to offer a retail ‘variety pack’ of similar but distinct products to a consumer. In order to prepare a variety pack for consumer purchase, it is often necessary to extract different individual varieties of pre-packaged product from standard (single variety) containers and then mix the multiple desired varieties into a single repackaged variety pack container.

As a specific example of this type of repackaging application, the adult beverage industry often offers variety packs of different flavors of a beverage within a single retail-ready package. Due to the batch nature of the preparation of an individual flavor of beverage at a beverage producer's facility, it is typically most efficient to produce and fill bottles or cans of a given flavor in large quantities. Often, the most efficient means to transfer the given flavor of product out of the production facility, even if it is ultimately destined to be grouped with other flavors into a variety pack, is to package the given flavor into a single-flavor carton that contains multiple individual cans or bottles. Once a single-flavor carton is packed, it leaves the production line, and multiple single-flavor cartons are then typically stacked together and ‘palletized’ so that they can be transported to another facility for repackaging with other flavors into variety packs.

In order to repackage various individual flavors into a variety pack, the individual flavor cans or bottles must be unpacked from their carton, and then the individual cans or bottles of a given flavor must be combined together with other cans or bottles of other flavors in order to achieve the desired mix of flavors, and then they must be repackaged once more.

The unpackaging, sometimes termed ‘unboxing’ or ‘deboxing’ of such original containers is a labor intensive and inefficient process. Often, the original containers are lifted manually from a pallet and moved onto a work surface, where they are then ripped or torn open manually. Once open, the product itself is often pushed manually onto a conveyor or similar transport device, so that it can then move to a next stage for further processing. In the case of the aforementioned adult beverage variety pack example, the unpackaged product will then enter into a packaging machine or system that will once again package the product, this time together with other desired products, into a desired new mixed-product container. In the adult beverage industry, it is common to have several production lines for unboxing the individual product flavors working in parallel with each other, wherein each production line is devoted to unboxing a single flavor of beverage.

Various problems exist with such a manual unpackaging process. The process is labor-intensive and requires significant lifting tasks, as well as aggressive tearing and ripping tasks that are burdensome and repetitive to human workers. These various unpackaging tasks can lead to worker fatigue and possible human injury. The original containers themselves, which have been ripped or torn apart, also require disposal. It is common that the disposal of the empty ripped or torn original containers is also an inefficient process. If the empty original containers are not quickly removed from the unpackaging area, they can cause the unboxed cans, bottles, or other products to tip and spill, stopping the production throughput and causing inefficiencies. Furthermore, simply pushing the unboxed individual products down the assembly line manually can also cause tipping or spillage.

Certain technologies exist within the unpackaging industry that have attempted to improve upon certain aspects of the manual unpackaging process, however they do not address the problem in its entirety. A solution is needed to automate the process of unpackaging a product in such a way as to move it successfully onward to a next operation without spillage or tipping of the unpackaged product, and in such a way as to efficiently remove the original packaging materials from the production line.

The invention described herein provides for an automated product unpackaging system to manipulate a target container onto a work surface and into an unpackaging work cell area, move the target container into and through a desired path within the work cell in such a way that lasers or other industrial cutters can cut through the surface material of the target container so that the target container's bottom surface is completely separated from the top and sides of the target container, and then to continue to move the top and sides of the target container, with its target product still encapsulated inside, slidingly onward toward a next operation. Once the still-encapsulated target product has been transferred to a desired location for a next operation, beyond the boundaries of the unpackaging system, the top and sides of the target container are then removed and extracted for disposal, along with the bottom surface of the target container.

### SUMMARY OF THE INVENTION

This section provides a general summary of the disclosure, and is not a comprehensive disclosure of its full scope or all of its features.

The application herein describes an automated product unpackaging system for unpackaging target product from a box or other generally flat-bottomed target container. The system uses commercially-known means such as conveyors, motors, air cylinders, actuators, belts, rollers, and work surfaces to manipulate the generally flat-bottomed ‘target container’, namely the container containing ‘target product’ that is desired to be unpackaged, into an unpackaging work cell area. Once the target container is in a desired location, the system then moves the target container into and through a desired path within the unpackaging work cell area in such a way that one or more lasers or other industrial cutters can cut through the target container's surface material on or near the ‘perimeter bottom edge’ of the target container, and wherein that perimeter bottom edge is defined as being the edge between the target container's generally flat bottom surface and its sides or sidewalls. Thusly defined, the act of cutting through the surface material of the target container along a closed path that follows on or near the target container's perimeter bottom edge will thereby completely separate the target container's flat bottom surface, or ‘bottom’ from the top and sides of the target container. In this way, the target container's top and sides, or ‘dome’ remains generally intact, and the target product remains encapsulated inside the interior of the target container's dome. The system will then transfer the dome of the target container, with its target product still encapsulated inside, slidingly onward across a work surface, out of the unpackaging work cell area and onward toward a next operation, beyond the scope of the invention, for further processing. Once the still-encapsulated target product has been transferred out of the unpackaging work cell area to a desired location for a next operation, the dome of the target container is then automatically removed and extracted for disposal, along with the separated bottom of the target container.

In certain preferred embodiments, the means to manipulate the target container through any one or more of the various desired positions—into the unpackaging work cell area, through the unpackaging work cell area during the cutting operation, and out of the unpackaging work cell area—is a powered conveyor or roller system, a gantry or crane, an industrial robot, or any combination thereof.

In certain embodiments, the means to rotate the target container into any one or more various positions is a powered split belt conveyor or similar mechanical mechanism. In other embodiments, the means to rotate the target container into any one or more various positions is an industrial robot.

Various embodiments can be configured for the physical layout of the unpackaging system. For example, the various work surfaces of the unpackaging system can be configured in a T-shape, a C-shape, a Z-shape, an L-shape, or an I-shape, as viewed from above.

In certain preferred embodiments, the means to remove and dispose of either or both of the dome of the target container and the bottom of the target container after the cutting operation is by the use of an industrial robot.

In certain preferred embodiments, the means to locate the position of the target container as it enters the unpackaging work cell area is by the use of a commercially available industrial vision system. In other embodiments, the position of the target container is controlled mechanically, by means of rails, bumpers, guides, or other similar mechanisms.

In certain preferred embodiments, the cutting operation is performed via at least one laser acting as the at least one cutter.

In certain embodiments, during the cutting operation, the means for cutting remain positionally stationary within the invention, held rigidly via a mechanical support system, represented herein as a ‘cutting gate’, and wherein cutting occurs within a ‘cutting zone’ as the target container is moved through the cutting gate and thereby past the cutting means, whereas in certain other embodiments the target container remains stationary while the means for cutting moves along the path of cut.

In certain preferred embodiments where at least one laser is employed for the cutting operation, a smoke extraction device is employed to reduce or eliminate smoke caused by the laser cutting process.

In certain preferred embodiments wherein the generally flat bottom of the target container is generally rectangular, the cutting operation can be performed in two stages. Specifically, the first stage of the cutting operation is enabled by two stationary industrial cutters held securely within a single cutting gate such that the two industrial cutters are positioned such that when the target container is moved in a linear path between the cutters, two opposing bottom edges of the target container are cut. In the second stage, two additional stationary cutters are positioned such that the target container can be moved in a second linear path between the two additional stationary cutters, such that the remaining two opposing bottom edges of the target container are cut, thereby completing the separation of the target container's dome from the target container's bottom.

In certain preferred embodiments for generally rectangular target containers, the at least one stationary cutters is a laser.

In certain preferred embodiments with at least one laser, the at least one laser can be positioned such that the cut beam enters the target container through its bottom surface. In certain preferred embodiments with at least one laser, the at least one laser is positioned such that the cut beam enters the target container through its side wall first, near the bottom perimeter edge of the target container. In certain preferred embodiments, the at least one laser cuts through only the side wall of the target container, and in other certain preferred embodiments, the at least one laser cuts through the side wall and the bottom surface of the target container.

Certain preferred embodiments further comprise a means to hold the generally flat bottom of the target container stationary after the cutting operation and to continue to hold it during the process wherein the dome of the target container, with its target product still encapsulated inside, is moved slidingly onward across a work surface, out of the unpackaging work cell area in such a way that the generally flat bottom of the target container does not slide.

In certain preferred embodiments where an industrial robot is employed to remove and dispose of the dome of the target container, and wherein the target container is generally box-shaped such that the dome is comprised of a generally flat top surface and generally flat, vertical side surfaces, the robot further comprises an end of arm tool or ‘EOAT’ that is movably programmed to remove the dome from the target product and then fold the sides of the dome inward in such a way that the side surfaces of the dome are flattened against the dome's top surface prior to its disposal from the system, in order to enable compact stacking of the disposed domes of multiple target containers after they exit the unpackaging system.

In certain preferred embodiments, the system further comprises a depalletizing operation that automatically removes individual target containers from a pallet or other stacked configuration and brings them, individually, into the unpackaging work cell for unpackaging. In certain preferred embodiments, this depalletizing operation is enabled via an industrial robot.

In certain preferred embodiments, the unpackaging system is controlled by an industrial computer or PLC.

In certain preferred embodiments, the individual target containers comprise an electronic barcode, QR code, or other machine-readable optical label that can contain information about each individual target container. In such embodiments, the industrial vision system can read information from such optical labels on each individual target container which can provide various instructions to the unpackaging system, such as indicating specifically where each target container should be most effectively cut open by the unpackaging system to avoid damaging the target product encapsulated inside, where the target product within each target container should be routed after the unpackaging is complete, and other relevant instructions that will be obvious to those persons having ordinary skill in the material handling industry.

For improved production throughput, various preferred embodiments can be configured by adding additional industrial robots, additional cutting gates, additional active conveyors, or any combination thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

In the drawings:

FIG. 1 represents prior art showing an embodiment of a generally box-shaped package, or target container.

FIG. 2 represents the aforementioned prior art target container with an established perimeter bottom edge cut as indicated, separating the generally flat bottom surface of the target container from the dome comprising the top and sides of the target container.

FIG. 3 represents the aforementioned prior art target container having been cut along the perimeter bottom edge, separated into two sections comprising a dome and a generally flat bottom surface and revealing encapsulated target product located inside.

FIG. 4 represents an embodiment of a cutting gate consisting of a rigid structural frame and at least one mounted industrial cutting device, which is represented herein as a laser.

FIG. 5 represents an embodiment of a cutting gate consisting of a one-dimensionally linearly adjustable two-sided frame with each side of said frame further comprising a securely-mounted industrial cutting device, namely a laser, wherein the adjustable frame having means such that the two sides of the linearly actuating adjustable frame can be moved together or apart to allow for varying distances between the two cutting devices.

FIG. 6 represents an embodiment of a cutting gate consisting of a two-dimensionally linearly adjustable frame with each side of said frame further comprising a securely-mounted industrial cutting device, namely a laser, wherein the adjustable frame having means such that the two sides of the linearly actuating adjustable frame can be moved together or apart to allow for varying distances between the two cutting devices and wherein the two sides of the linearly actuating adjustable frame have means such as a lead screw as represented here, which can each be raised or lowered to allow for varying distances between the two cutting devices and the work surface.

FIG. 7 illustrates a prior art embodiment of a commercially-available industrial vision system with means to locate the size and position of a target container.

FIG. 8 illustrates prior art of a machine-readable optical label, represented herein as a QR code, that can communicate relevant data about a target container to the unpackaging system.

FIG. 9 illustrates how such an optical label as depicted in FIG. 8 can be affixed to a target container such that data can be transmitted to an industrial vision system.

FIG. 10a illustrates a top-view layout of a preferred mechanical embodiment of the invention in which the target container is a generally rectangular box-shaped container and the system layout comprises a T-shaped configuration using a single cutting gate comprising two industrial cutters, an industrial vision system, an industrial robot, and various conveyors.

FIG. 10b illustrates a first step of the functionality of the machine layout outlined in FIG. 10a wherein a target container enters the invention via conveyor or similar means.

FIG. 10c illustrates a second step of the functionality of the machine layout outlined in FIG. 10a wherein the target container's position is determined by a vision system.

FIG. 10d illustrates a third step of the functionality of the machine layout outlined in FIG. 10a wherein the industrial robot has received information about the target container's position from the vision system and has securely gripped the target container and moved it along the work surface toward the cutting zone of the invention.

FIG. 10e illustrates a fourth step of the functionality of the machine layout outlined in FIG. 10a wherein the industrial robot passes the target container through the cutting zone of the invention such that two opposite perimeter bottom edges of the target container are cut.

FIG. 10f illustrates a fifth step of the functionality of the machine layout outlined in FIG. 10a wherein the industrial robot rotates the target container ninety degrees about an axis perpendicular to the work surface.

FIG. 10g illustrates a sixth step of the functionality of the machine layout outlined in FIG. 10a wherein the industrial robot passes the target container through the cutting zone of the invention such that the remaining two opposite perimeter bottom edges of the target container, which were previously uncut, are cut.

FIG. 10h illustrates a seventh step of the functionality of the machine layout outlined in FIG. 10a wherein the industrial robot moves the target container out of the cutting zone and the dome of the target container, with target product still encapsulated inside, is separated from the bottom of the target container.

FIG. 10i illustrates an eighth step of the functionality of the machine layout outlined in FIG. 10a wherein the target product exits the invention, separated from the target container's dome and bottom, and moves onward to a next operation, and wherein the bottom of the target container is retained for later disposal, and the dome of the target container is disposed.

FIG. 11 illustrates a top-view layout of an alternative preferred mechanical embodiment of the invention in which the target container is a generally rectangular box-shaped container and the system layout comprises a ‘C-shaped’ configuration using a single cutting gate comprising two industrial cutters, an industrial vision system, an industrial robot, and various conveyors.

FIG. 12 illustrates a top-view layout of an alternative preferred mechanical embodiment of the invention in which the target container is a generally rectangular box-shaped container and the system layout comprises a ‘zigzag-shaped’ configuration using a single cutting gate comprising two industrial cutters, an industrial vision system, an industrial robot, and various conveyors.

FIG. 13 illustrates a top-view layout of an alternative preferred mechanical embodiment of the invention in which the target container is a generally rectangular box-shaped container and the system layout comprises a ‘reverse-zigzag-shaped’ configuration using a single cutting gate comprising two industrial cutters, an industrial vision system, an industrial robot, and various conveyors.

FIG. 14 illustrates a top-view layout of an alternative preferred mechanical embodiment of the invention in which the target container is a generally rectangular box-shaped container and the system layout comprises an ‘L-shaped’ configuration using a single cutting gate comprising two industrial cutters, an industrial vision system, an industrial robot, and various conveyors.

FIG. 15 illustrates a top-view layout of an alternative preferred mechanical embodiment of the invention in which the target container is a generally rectangular box-shaped container and the system layout comprises a ‘reverse-L-shaped’ configuration using a single cutting gate comprising two industrial cutters, an industrial vision system, an industrial robot, and various conveyors.

FIG. 16a Illustrates an ‘I-shaped’, or straight-line, mechanical embodiment of the invention in which the target container is a generally rectangular box-shaped container and the system configuration comprises two cutting gates, each comprising two industrial cutters, an industrial vision system, two industrial robots, and various conveyors.

FIG. 16b illustrates a first step of the functionality of the machine layout outlined in FIG. 16a wherein a target container enters the invention via conveyor or similar means.

FIG. 16c illustrates a second step of the functionality of the machine layout outlined in FIG. 16a wherein the target container's position is determined by an industrial vision system.

FIG. 16d illustrates a third step of the functionality of the machine layout outlined in FIG. 16a wherein a first industrial robot has received information about the target container's position from the vision system and has securely gripped the target container and moved it along the work surface toward the cutting zone of the invention.

FIG. 16e illustrates a fourth step of the functionality of the machine layout outlined in FIG. 16a wherein the first industrial robot passes the target container through the cutting zone of the invention such that two opposite perimeter bottom edges of the target container are cut.

FIG. 16f illustrates a fifth step of the functionality of the machine layout outlined in FIG. 16a wherein the first industrial robot rotates the target container ninety degrees about an axis perpendicular to the work surface.

FIG. 16g illustrates a sixth step of the functionality of the machine layout outlined in FIG. 16a wherein the first industrial robot passes the target container to a second industrial robot, which in turn passes the target container through the cutting zone of the invention such that the remaining two opposite perimeter bottom edges of the target container, which were previously uncut, are cut.

FIG. 16h illustrates a seventh step of the functionality of the machine layout outlined in FIG. 16a wherein the second industrial robot moves the target container out of the cutting zone and the dome of the target container, with target product still encapsulated inside, is separated from the bottom of the target container.

FIG. 16i illustrates an eighth step of the functionality of the machine layout outlined in FIG. 16a wherein the target product exits the invention, separated from the target container's dome and bottom, and moves onward to a next operation, and wherein the bottom of the target container is retained for later disposal, and the dome of the target container is disposed by the second industrial robot.

FIG. 17a Illustrates an alternative ‘I-shaped’, or straight-line, mechanical embodiment of the invention in which the target container is a generally rectangular box-shaped container and the system configuration comprises two cutting gates, each comprising two industrial cutters, an industrial vision system, one industrial robot, and various powered conveyors.

FIG. 17b illustrates a first step of the functionality of the machine layout outlined in FIG. 17a wherein a target container enters the invention via a first segment of powered conveyor.

FIG. 17c illustrates a second step of the functionality of the machine layout outlined in FIG. 17a wherein the target container's position is determined by an industrial vision system.

FIG. 17d illustrates a third step of the functionality of the machine layout outlined in FIG. 17a wherein the target container's position is adjusted by mechanical guides securably positioned along the work surface, while the powered conveyor moves the target container toward the cutting zone of the invention.

FIG. 17e illustrates a fourth step of the functionality of the machine layout outlined in FIG. 17a wherein the powered conveyor passes the target container through the cutting zone of the invention such that two opposite perimeter bottom edges of the target container are cut.

FIG. 17f illustrates a fifth step of the functionality of the machine layout outlined in FIG. 17a wherein a commercially-available split conveyor rotates the target container ninety degrees about an axis perpendicular to the work surface.

FIG. 17g illustrates a sixth step of the functionality of the machine layout outlined in FIG. 17a wherein a second segment of powered conveyor passes the target container through the cutting zone of the invention such that the remaining two opposite perimeter bottom edges of the target container, which were previously uncut, are cut.

FIG. 17h illustrates a seventh step of the functionality of the machine layout outlined in FIG. 17a wherein an industrial robot moves the target container onward out of the cutting zone and the dome of the target container, with target product still encapsulated inside, is separated from the bottom of the target container.

FIG. 17i illustrates an eighth step of the functionality of the machine layout outlined in FIG. 17a wherein the target product exits the invention, separated from the target container's dome and bottom, and moves onward to a next operation, and wherein the bottom of the target container is retained for later disposal, and the dome of the target container is disposed by the second industrial robot.

FIG. 18 Illustrates a perspective overview of a preferred mechanical embodiment of the invention that comprises a system layout in a zigzag-shaped configuration operating in parallel with a system layout in a reverse-zigzag-shaped configuration.

FIG. 19 illustrates the embodiment concept shown in FIG. 18 coupled with a commercially-available depalletizing system and a means for waste disposal.

FIG. 20 illustrates the aforementioned embodiment concept in FIG. 19 from another angle of view.

FIG. 21 illustrates the embodiment concept shown in FIG. 20 coupled with a smoke capture hood, an industrial vision system, and an industrial PLC.

### DETAILED DESCRIPTION

Example embodiments will be described more fully with reference to the accompanying drawings.

The accompanying drawings are provided to provide illustrative examples of certain preferred embodiments of the invention. Throughout the accompanying drawings, the target container is represented graphically as a box of arbitrary size, but the target container can be any generally flat-bottomed container with generally vertical sidewalls and a top surface.

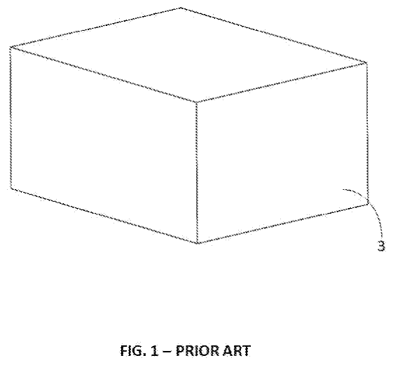

Referring now to prior art as depicted in FIG. 1, a flat-bottomed target container 3 is represented as a rectangular box of arbitrary size (length, width, and height) and arbitrary construction.

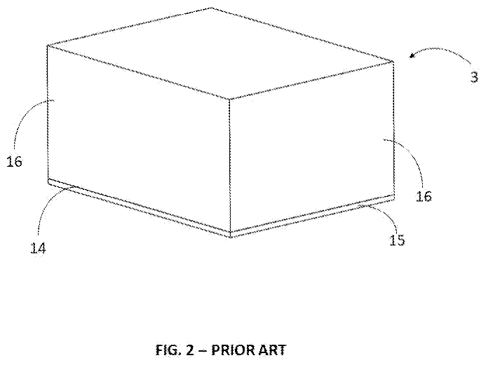

Referring now to FIG. 2, the target container 3 from FIG. 1 is represented with an established perimeter bottom edge 14 shown as a cut line through the sidewalls 16 of target container 3 wherein the cut position is near the bottom surface 15.

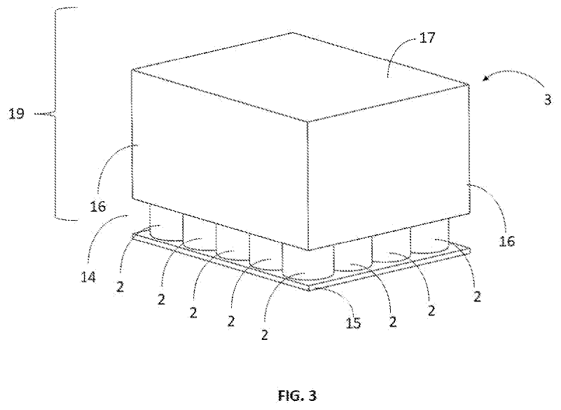

Referring now to FIG. 3, the same target container 3 from FIGS. 1 and 2 is represented after it has been separated along the perimeter bottom edge 14, exposing target products 2 and thusly forming a separate and distinct flat bottom surface 15 and a dome 19 which comprises the sidewalls 16 and the top 17. It is expected, as represented, that in certain embodiments some portion of the sidewalls 16 will remain with the flat bottom surface 15.

Referring now to FIG. 4, an embodiment of a cutting gate 26 is represented. This embodiment comprises two stationary cutters 22 that create a cutting action. The stationary cutters 22 are depicted as lasers 12. The space between the stationary cutters 22 is the cutting zone 6.

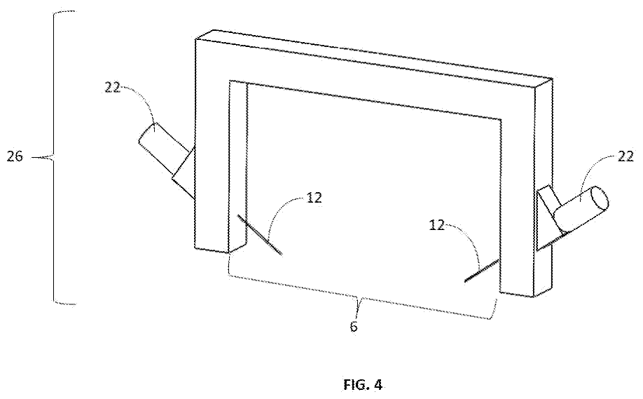

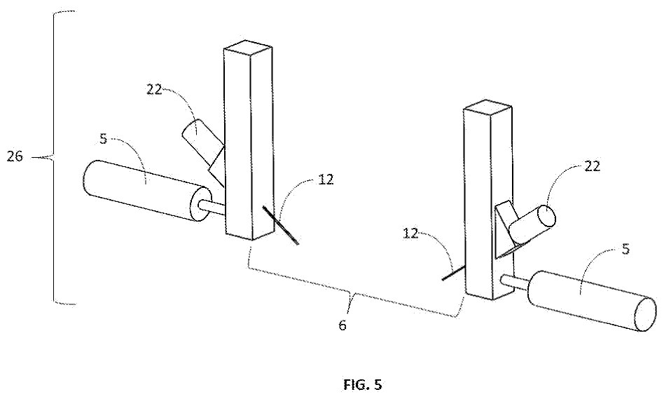

Referring now to FIG. 5, an embodiment of a cutting gate 26 is depicted. This embodiment comprises two stationary cutters 22. The cutting action of the stationary cutters 22 are each depicted herein as lasers 12. The space between the industrial cutters 12 is the cutting zone 6. The distance between the two stationary cutters 22 can vary in one degree of freedom via an actuator air cylinder 5.

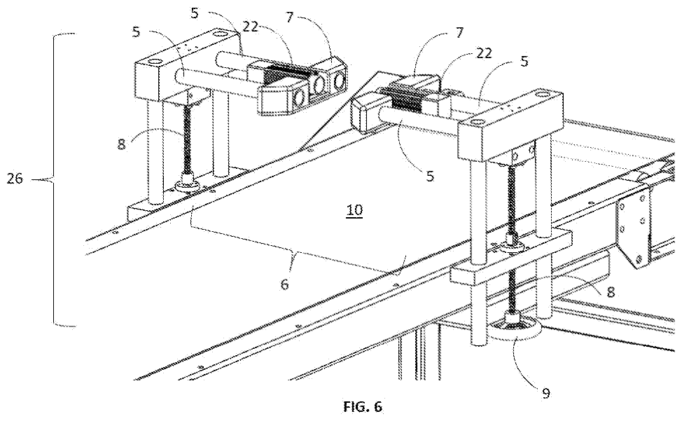

Referring now to FIG. 6, a preferred embodiment of a cutting gate 26 is depicted. This embodiment comprises two stationary cutters 22. Between the two cutters 22 is a cutting zone 6 where a target container (not depicted) would travel to be processed. The cutters 22 have two degrees of positional freedom. In one dimension, depicted horizontally, the relative distance between the cutters 22 can vary in one degree of freedom via actuators depicted as air cylinders 5. In a second dimension, depicted vertically, the distance between the cutters 22 and the work surface 10 can vary, enabled as depicted via lead screws 8 and a motor or manual rotational actuation 9 to permit height adjustment. Bumpers 7 are depicted to ensure that alignment of cutters 22 with the target container (not depicted) during the cutting process.

Referring now to FIG. 7, a prior art embodiment of a commercially available industrial vision system comprising a stationary camera 37 spanning over a worksurface depicted as conveyor belt 4 is represented. The camera 37 is positioned over the vision targeting zone 32 allowing view of a target container 3 such that relevant position and shape of target container 3 can be captured by camera 37.

Referring now to prior art as depicted in FIG. 8, a machine-readable optical label 38 is depicted. In this example the QR code reads: ‘Shipping to: Custom Technologies LLC—Contains Hazardous Materials—Do Not Open with Heat Source’.

Referring now to FIG. 9, depicted the same embodiment as described in FIG. 7, but wherein the target containers 3 have been affixed with optical labels 38 as described in FIG. 8. In this case, the optical labels 38 read ‘Shipping to: Custom Technologies LLC—Contains Hazardous Materials—Do Not Open With Heat Source.’ An Industrial PLC (not depicted) can use camera 37 to read such or similar data to provide instructional data to the invention as to specific behaviors relevant for specific target container 3.

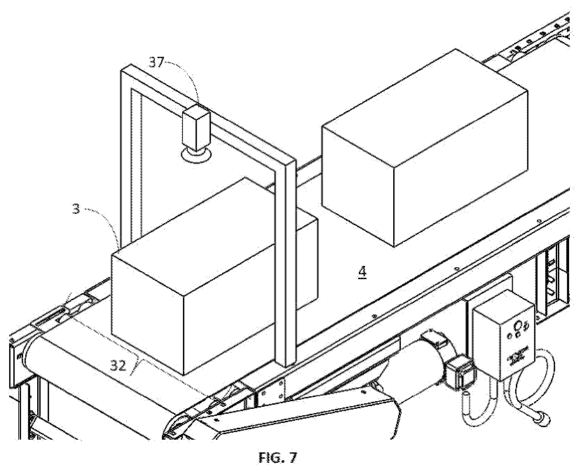

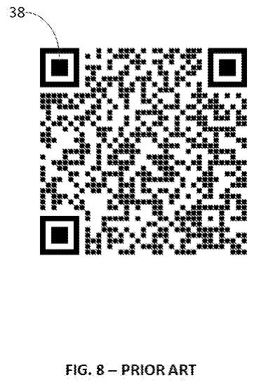

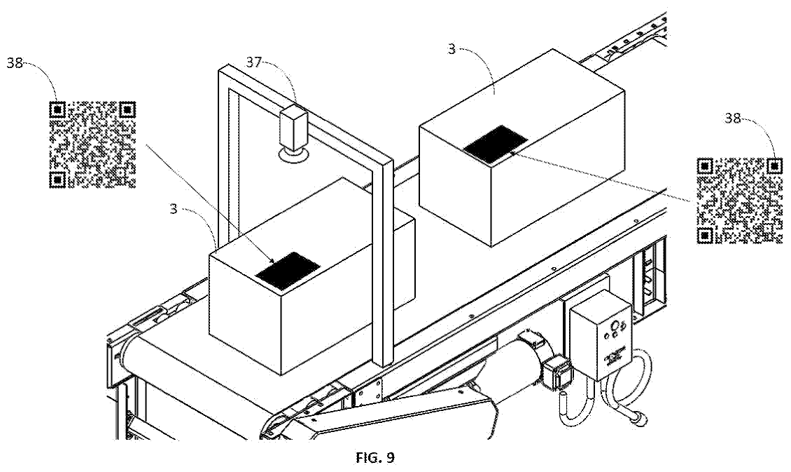

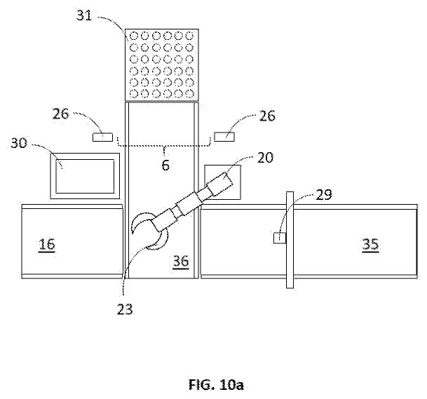

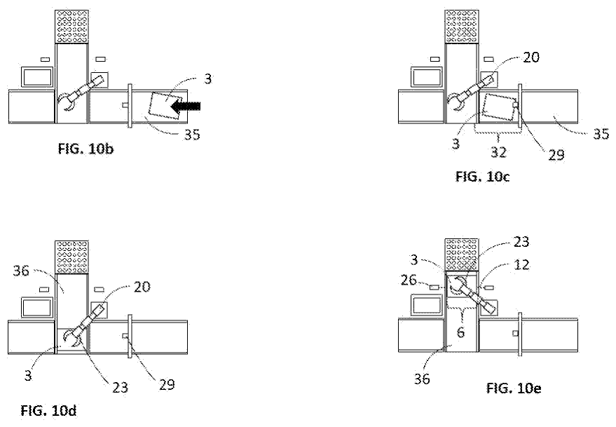

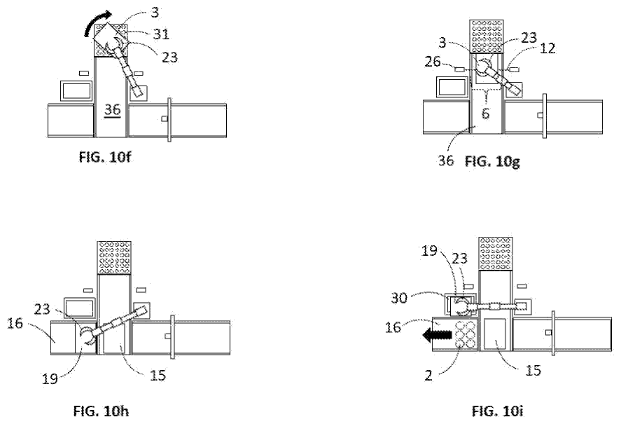

Referring now to FIG. 10a, a top-view layout of a preferred mechanical embodiment of the invention is depicted with a single cutting zone 6 and a single industrial robot 20. This preferred embodiment is composed of an entrance conveyor 35, a process conveyor 36, and an exit conveyor 16. These conveyors are arranged in a ‘T’ shape, with the entrance conveyor 35 and the exit conveyor 16 co-linear. Two cutting gates 26, located opposite each other and securably affixed to process conveyor 36 define the cutting zone 6. At the end of process conveyor 36 is a passive rotation device 31 depicted as a table of ball bearings. Flanking process conveyor 36 is a waste disposal zone 30 and an industrial robot 20 depicted with end of arm tooling “EOAT” 23 affixed at the end of robot 20. Spanning the entrance conveyor 35 is an industrial vision system 29.

For further clarity, FIG. 10b depicts the first step of a preferred operational flow of the invention. At this stage a target container 3 enters the invention on an entrance conveyor 35.

For further clarity, FIG. 10c depicts the second step of a preferred operational flow of the invention. At this stage the entrance conveyor 35 carries target container 3 into the vision targeting zone 32, where industrial vision system 29 images target container 3 to enable communication to industrial robot 20, informing the relative location of target container 3.

For further clarity, FIG. 10d depicts the third step of a preferred operational flow of the invention. At this stage the EOAT 23 travels on the end of the industrial robot arm 20 to the location of the target container 3 as communicated by the robotic vision system 29. The EOAT 23 securably grips target container 3 and slides it to process conveyor 36 and aligns the position of target container 3 with process conveyor 36.

For further clarity, FIG. 10e depicts the fourth step of a preferred operational flow of the invention. Together, the EOAT 23 and conveyor 36 move target container 3 into cutting zone 6, passing through cutting gate 26. At this time, a cut through the exterior of target container 3 is made by the industrial cutter 12, cutting along a defined perimeter bottom edge on two opposite sidewalls of target container 3.

For further clarity, FIG. 10f depicts the fifth step of a preferred operational flow of the invention. The EOAT 23 slides target container 3 off conveyor 36 onto passive rotation surface 31 and rotates target container 3 ninety degrees around an axis perpendicular to the passive rotation surface 31.

For further clarity, FIG. 10g depicts the sixth step of a preferred operational flow of the invention. Together, the EOAT 23 and conveyor 36 move target container 3 back into the cutting zone 6 and through the cutting gate 26. At this time, a cut through the exterior surface of target container 3 is made by the industrial cutter 12 along the defined perimeter bottom edge on the two remaining uncut sidewalls of target container 3.

For more clarity, FIG. 10h depicts the seventh step of a preferred operational flow of the invention. At this point the dome 19 of the target container is fully detached from the bottom 15. The EOAT 23 slides the dome 19 off the bottom 15 onto exit conveyor 16. All target products (not depicted) formerly encapsulated inside the target container are encapsulated within dome 19.

For more clarity, FIG. 10i depicts the eighth step of a preferred operational flow of the invention. At this point the dome 19 is lifted off target products 2 by the EOAT 23 and is dispensed into waste disposal zone 30. The products 2 are free to travel out of the invention by way of conveyor 16 towards a next operation. The bottom 15 is picked up by the EOAT 23 and disposed of into the waste disposal zone 30.

Referring now to FIG. 11, which depicts a top-view layout of a preferred embodiment of the invention which comprises two cutting zones 6 and a single industrial robot 20. This embodiment of the invention is depicted without target product in order to detail the major subsystems. The embodiment is comprised of an entrance conveyor 35, two process conveyors 36, and an exit conveyor 16. These conveyors are arranged in a ‘C’ shape with the entrance conveyor 35 and the exit conveyor 16 in parallel, forming the top and bottom rightmost bounds of the invention, as depicted. Process conveyors 36 form an ‘L-shape’ completing the left bound of the invention's layout as depicted. Spanning across both process conveyors 36 are cutting gates 26 that defines the cutting zones 6. Within the ‘C’ shape is a waste disposal zone 30 and an industrial robot 20 with EOAT 23 affixed at the end of industrial robot 20. Spanning the entrance conveyor 35 is industrial vision system 29.

Referring now to FIG. 12, which depicts a top-view layout of an alternative preferred mechanical embodiment of the invention featuring a double cutting zone 6 and a single industrial robot 20. This embodiment of the invention is depicted without target product in order to detail the major subsystems. The embodiment is comprised of an entrance conveyor 35, two process conveyors 36, and an exit conveyor 16. These conveyors are arranged in a ‘zigzag-shaped’ configuration with the entrance conveyor 35 and the first process conveyor 36 perpendicular, forming a first ninety-degree turn. Process conveyors 36 form a right angle to form a second ninety degree turn ,with an exit conveyor 16 at the top end, as depicted in this view. Spanning across both process conveyors 36 are cutting gates 26 that define the cutting zones 6. Internal to the second right angle a waste disposal zone 30 is depicted, together with an industrial robot 20 with EOAT 23 affixed at the end of the industrial robot 20. Spanning the entrance conveyor 35 is industrial vision system 29.

Referring now to FIG. 13, which depicts a top-view layout of an alternative preferred mechanical embodiment of the invention featuring a double cutting zone 6 and a single industrial robot 20. This embodiment of the invention is depicted without target product in order to detail the major subsystems. The embodiment is comprised of an entrance conveyor 35, two process conveyors 36, and an exit conveyor 16. These conveyors are arranged in a ‘reverse-zigzag-shaped’ configuration with the entrance conveyor 35 and the first process conveyor 36 perpendicular, forming a first ninety-degree turn. Process conveyors 36 form a right angle to form a second ninety degree turn, with an exit conveyor 16 at the top end, as depicted in this view. Spanning across both process conveyors 36 are cutting gates 26 that define the cutting zones 6. Internal to the second right angle a waste disposal zone 30 is depicted, together with an industrial robot 20 with EOAT 23 affixed at the end of the industrial robot 20. Spanning the entrance conveyor 35 is industrial vision system 29.

Referring now to FIG. 14, which depicts a top-view layout of an alternative preferred mechanical embodiment of the invention which features a double cutting zone 6 and a single industrial robot 20. This embodiment of the invention is depicted without target product in order to detail the major subsystems. The embodiment is comprised of an entrance conveyor 35, two process conveyors 36, and an exit conveyor 16. These conveyors are arranged in a ‘L-shaped’ configuration with the entrance conveyor 35 and the first process conveyor 36 forming the long leg of the L. An additional process conveyor 36 and exit conveyor 16 form the short leg of the L, as depicted. Spanning across both process conveyors 36 are cutting gates 26 that define the cutting zones 6. Internal to the right angle is a waste disposal zone 30 and an industrial robot 20 with EOAT 23 affixed at the end of its length. Spanning the entrance conveyor 35 is industrial vision system 29.

Referring now to FIG. 15, which depicts a top-view layout of an alternative preferred mechanical embodiment of the invention which features a double cutting zone 6 and a single industrial robot 20. This embodiment of the invention is depicted without target product in order to detail the major subsystems. The embodiment is comprised of an entrance conveyor 35, two process conveyors 36, and an exit conveyor 16. These conveyors are arranged in a ‘reverse-L-shaped’ configuration with the entrance conveyor 35 and the first process conveyor 36 forming the long leg of the L. An additional process conveyor 36 and exit conveyor 16 form the short leg of the L, as depicted. Spanning across both process conveyors 36 are cutting gates 26 that define the cutting zones 6. Internal to the right angle is a waste disposal zone 30 and an industrial robot 20 with EOAT 23 affixed at the end of its length. Spanning the entrance conveyor 35 is industrial vision system 29.

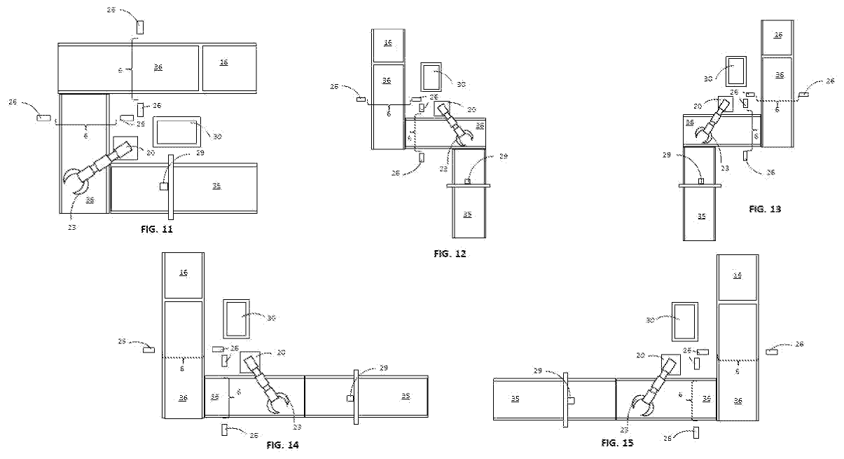

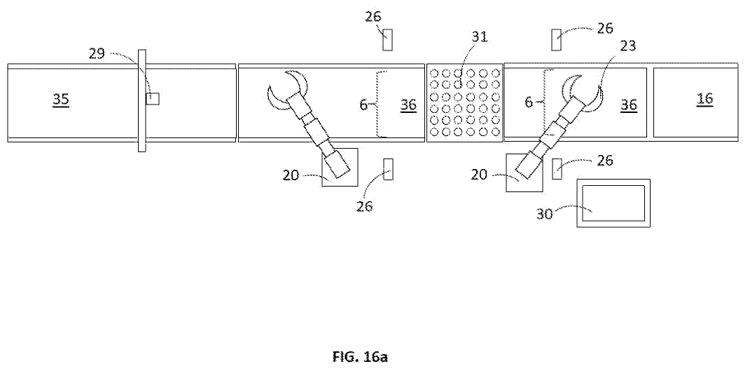

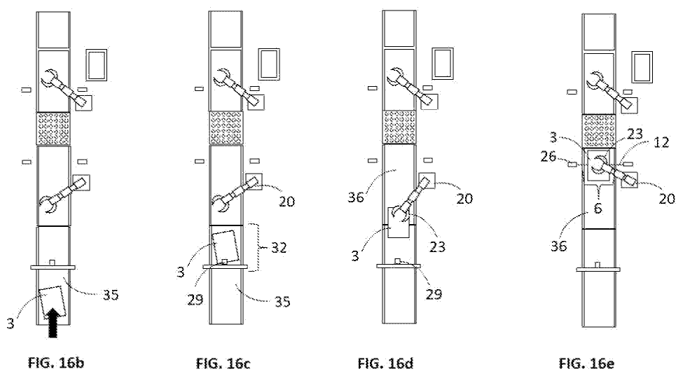

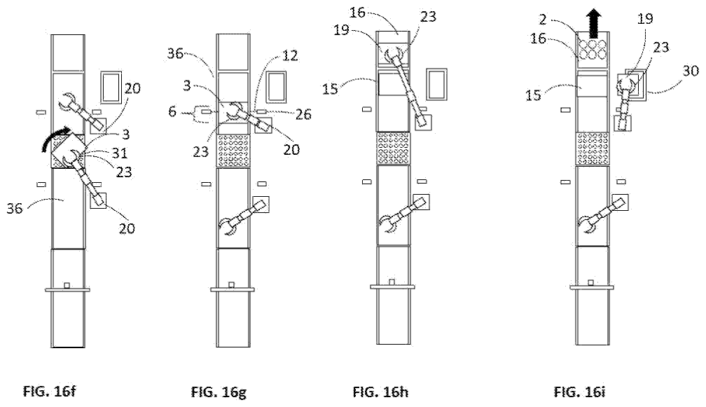

Referring now to FIG. 16a, which depicts a top-view layout of a preferred mechanical embodiment of the invention which comprises a double cutting zone 6 and two industrial robots 20. This embodiment of the invention is depicted without target product in order to detail the major subsystems. The embodiment comprises an entrance conveyor 35, two process conveyors 36, a passive rotation surface 31 and an exit conveyor 16. These conveyors are arranged in a straight line or “I-shaped” configuration and are all co-linear as represented. Spanning across each process conveyor 36 is a cutting gate 26 that defines the cutting zones 6. In between the process conveyors 36 is a passive rotation device 31 depicted as a table of ball bearings. Adjacent to process conveyor 36 is a waste disposal zone 30 and two industrial robots 20 with EOAT 23 affixed at the end. Spanning the entrance conveyor 35 is an industrial vision system 29.

For further clarity, FIG. 16b depicts the first step of a preferred operational flow of the invention. At this stage a target container 3 enters the invention on an entrance conveyor 35.

For further clarity, FIG. 16c depicts the second step of a preferred operational flow of the invention. At this stage the entrance conveyor 35 carries target container 3 into the vision targeting zone 32, where industrial vision system 29 images target container 3 to enable communication to industrial robot 20, informing the relative location of target container 3.

For further clarity, FIG. 16d depicts the third step of a preferred operational flow of the invention. At this stage the EOAT 23 travels on the end of the industrial robot arm 20 to the location of the target container 3 as communicated by the robotic vision system 29. The EOAT 23 securably grips target container 3 and slides it to process conveyor 36 and aligns the position of target container 3 with process conveyor 36.

For further clarity, FIG. 16e depicts the fourth step of a preferred operational flow of the invention. Together, the industrial robot 20, EOAT 23, and conveyor 36 move target container 3 into cutting zone 6, passing through cutting gate 26. At this time, a cut through the exterior of target container 3 is made by the industrial cutter 12, cutting along a defined perimeter bottom edge on two opposite sidewalls of target container 3.

For further clarity, FIG. 16f depicts the fifth step of a preferred operational flow of the invention. The EOAT 23 slides target container 3 off conveyor 36 onto passive rotation surface 31 and rotates target container 3 ninety degrees around an axis perpendicular to the passive rotation surface 31 and leaves target container 3 in a known position such that the second industrial robot 20 can securably grasp target container 3, thereby transferring movement control of target container 3 from first robot 20 to second robot 20.

For further clarity, FIG. 16g depicts the sixth step of a preferred operational flow of the invention. Together, the EOAT 23 and conveyor 36 move target container 3 onward (upward as depicted) to a second cutting zone 6 and through a second cutting gate 26. At this time, a cut through the exterior surface of target container 3 is made by the industrial cutter 12 along the defined perimeter bottom edge on the two remaining uncut sidewalls of target container 3.

For more clarity, FIG. 16h depicts the seventh step of a preferred operational flow of the invention. At this point the dome 19 of the target container (no longer depicted intact) is fully detached from the bottom 15. The EOAT 23 slides the dome 19 off the bottom 15 onto exit conveyor 16. All target products (not depicted) formerly encapsulated inside the target container are encapsulated within dome 19.

For more clarity, FIG. 16i depicts the eighth step of a preferred operational flow of the invention. At this point the dome 19 is lifted off target products 2 by the EOAT 23 and is dispensed into waste disposal zone 30. The products 2 are free to travel out of the invention by way of conveyor 16 towards a next operation beyond the invention. The bottom 15 is picked up by the EOAT 23 and disposed of into the waste disposal zone 30.

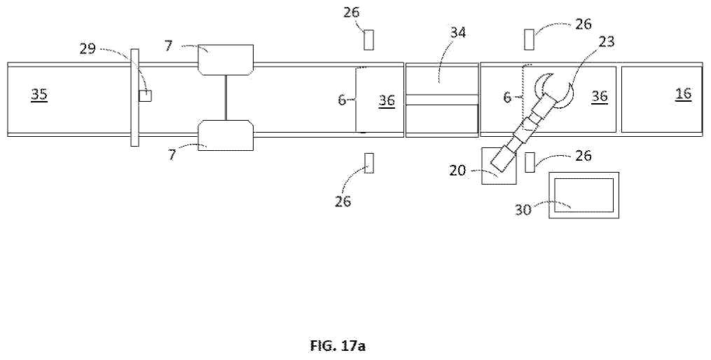

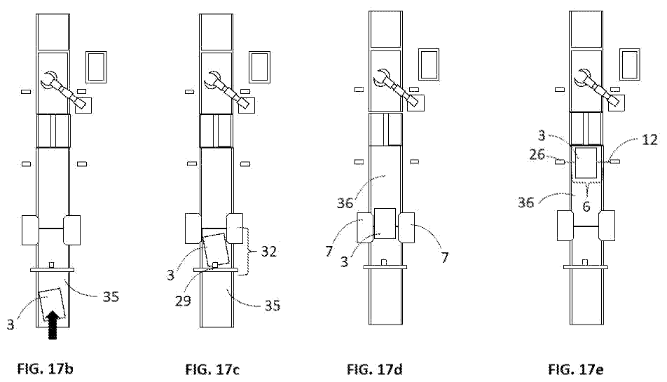

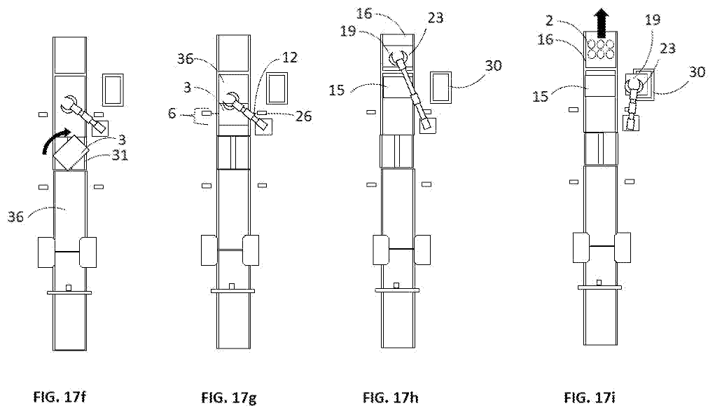

Referring now to FIG. 17a, which illustrates a top-view layout of an alternative preferred mechanical embodiment of the invention which features a double cutting zone 6 and a single industrial robot 20. This embodiment of the invention is depicted without target product in order to detail the major subsystems. The embodiment is composed of an entrance conveyor 35, two process conveyors 36, a powered rotation device 34 and an exit conveyor 16. These conveyors are arranged in a straight line or “I-shaped” configuration and are all co-linear. Spanning across each process conveyor 36 is a cutting gate 26 that defines each cutting zone 6. In between the process conveyors 36 is a powered rotation device 34, depicted herein as a split belt. On the left most end, as depicted, of the process conveyors 36 is a waste disposal zone 30 and an industrial robot 20 with EOAT 23 affixed at the end. Spanning the entrance conveyor 35 is an industrial vision system 29 and alignment bumpers 7.

For more clarity, FIG. 17b depicts the first step of the operational flow of the system. At this point a target container 3 enters the invention on an entrance conveyor 35.

For more clarity, FIG. 17c depicts the second step of the operational flow of the system. At this point the conveyor 35 carries the box 3 into the vision targeting zone 32, where industrial vision system 29 images the target container 3 and captures any relevant data located thereon.

For more clarity, FIG. 17d depicts the third step of the operational flow of the system. The entrance conveyor 35 moves target container 3 through a self-alignment bumper 7 and slides it to process conveyor 36.

For more clarity, FIG. 17e depicts the fourth step of the operational flow of the system. Conveyor 36 moves target container 3 upward as depicted in this view into a first cutting zone 6 through a first cutting gate 26. At this time, the industrial cutter 12 makes a cut through the exterior of the target container 3 along the defined perimeter bottom edge (not depicted) on two opposing sidewalls of target container 3.

For more clarity, FIG. 17f depicts the fifth step of the operational flow of the system. Conveyor 36 slides the target container 3 off onto powered rotation surface 31 which rotates target container 3 ninety degrees along an axis perpendicular to the page of view.

For more clarity, FIG. 17g depicts the sixth step of the operational flow of the system. Conveyor 36 moves target container 3 into a second cutting zone 6 through a second cutting gate 26. At this time, a cut is made by an industrial cutter 12 through the exterior of the target container 3 is made along the defined perimeter bottom edge (not depicted) on the two remaining uncut sidewalls of target container 3.

For more clarity, FIG. 17h depicts the seventh step of the operational flow of the system. At this point the dome 19 of target container (no longer depicted) is fully detached from the bottom 15. The EOAT 23 slides the dome 19 off the bottom 15 onto exit conveyor 16. All products formerly within the target container are encapsulated, but not depicted, within the dome 19.

For more clarity, FIG. 17i depicts the eighth step of the operational flow of the system. At this point the dome 19 is lifted off the target products 2 by EOAT 23 and is dispensed into the waste disposal zone 30. The target products 2 are thereby free to travel out of the invention by way of exit conveyor 16. The bottom 15 is picked up by the EOAT 23 and disposed of into the waste disposal zone 30.

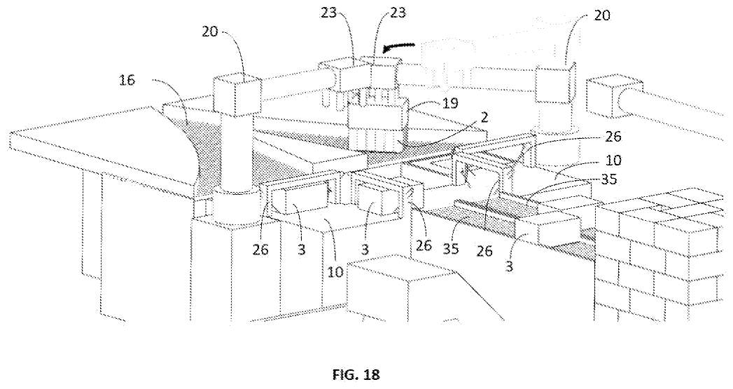

Referring now to FIG. 18, which depicts a perspective view of a preferred mechanical embodiment of the invention that comprises a system layout itself comprised of two independent subsystems, one depicted as zigzag-shaped configuration pursuant to the layout previously depicted in FIG. 12 and one depicted as a reverse-zigzag-shaped configuration pursuant to the layout previously depicted in FIG. 13. The combined system thusly shares an entrance conveyor 35 on which target containers 3 may travel and thusly be sorted into one subsystem or the other, depending on the operator's preference. Both subsystems merge into a singular exit conveyor 16. Each subsystem has its own set of cutting gates 26, industrial robot 20, EOAT 23, and worksurface 10. As in previous embodiments depicted, target products 2 are encapsulated within target containers 3 which are split by the invention into a dome 19 and a bottom (not depicted) thereby enabling target products 2 to be sent onward to a downstream process out of the invention.

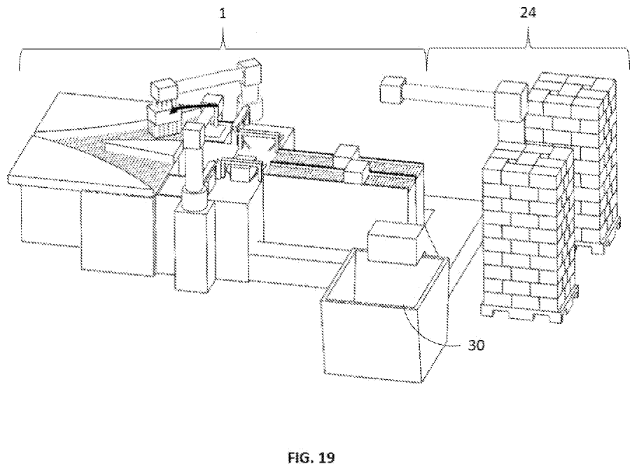

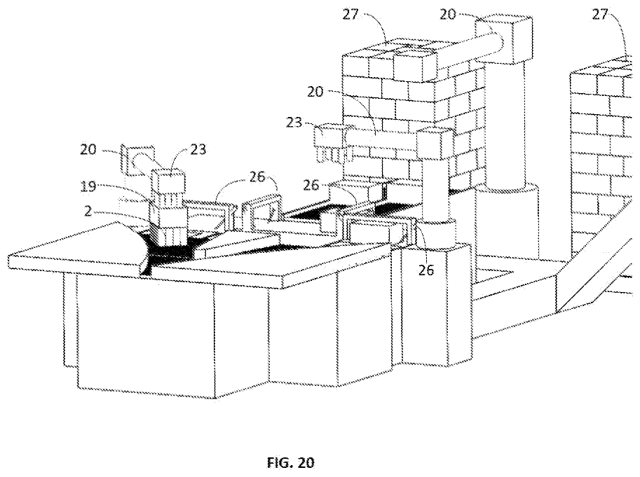

Referring now to FIG. 19, the view depicts the same embodiment of the invention 1 from FIG. 18, but with the addition of a commercially available depalletizing system 24 as well as a commercially available waste disposal bin 30.

For clarity FIG. 20, shows the same embodiment from FIG. 19 from another frame of view. Each subsystem comprises cutting gates 26, Industrial robot 20, and EOAT 23. Target products 2 are encapsuated in target containers 3 which are split by the invention into a dome 19 and a bottom (not depicted), thereby enabling the target products 2 to exit the invention toward a next operation. Also depicted is an additional commercially available industrial robot 20 flanked by two stacks of palleted boxes 27, representing a commercially available depalletization system.

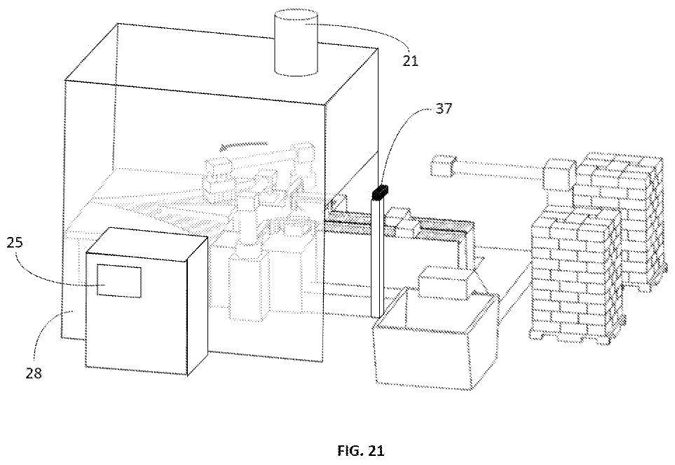

Referring now to FIG. 21, which depicts the same embodiment from FIG. 19 with the addition of a commercially available smoke capture hood 28, ductwork 21 to vent the contents of the hood 28, as well as an industrial vision system 37, and an industrial PLC 25.

The foregoing description of the embodiments, along with the provided drawings, has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed:

1. An unpackaging system for removing target product from inside a target container, comprising: a means to positionally locate a target container, said target container itself comprising a generally flat bottom surface and a dome, and said target container containing a target product within said target container, a means to move said target container into an unpackaging work cell; a means to cut the bottom surface separably apart from the dome of said target container; a means to slidably move the dome of said target container, together with the target product still securely encapsulated inside the dome, out of said unpackaging work cell; a means to remove and dispose of said dome of said target container; and a means to remove and dispose of said bottom surface of said target container.

2. An unpackaging system as in claim 1, wherein the means to move the target container is a robot.

3. An unpackaging system as in claim 1, wherein the means to slidably move the dome of said target container, together with the target product still securely encapsulated inside the dome, out of said unpackaging work cell, is a robot.

4. An unpackaging system as in claim 1, wherein the means to remove and dispose of said dome of said target container is a robot.

5. An unpackaging system as in claim 1, wherein the means to remove and dispose of said bottom surface of said target container is a robot.

6. An unpackaging system as in claim 1, wherein the means to cut the bottom surface separably apart from the dome of said target container is a laser.

7. An unpackaging system as in claim 6, wherein the laser is stationary during the cutting action and wherein the target container is moved past the laser during the cutting action by a robot.

8. An unpackaging system as in claim 1, wherein the means to positionally locate said target container is an industrial vision system.

9. A method for unpackaging target product from inside a generally flat-bottomed target container comprising: positionally locating a target container, moving the target container into a desired position inside an unpackaging work cell; cutting through the surface of the target container along a closed path that follows on or near the target container's perimeter bottom edge near its sidewalls such that the target container's flat bottom surface is separated from the top and sides, or dome, of the target container; moving the separated dome of the target container, together with its target product still encapsulated inside the dome, out of the unpackaging work cell and to a desired exit point; removing said dome from the target product; disposing of said dome into a desired disposal container; and disposing of said separated bottom surface into a desired disposal container.

10. A method for unpackaging target product as in claim 9, wherein the moving of the target container is enabled by a robot and the cutting through the surface of the target container is enabled by a laser.

11. A method for unpackaging target product as in claim 9, wherein the moving of the target container is enabled by a powered conveyor.

12. A method for unpackaging target product from inside a generally flat-bottomed target container comprising: moving the target container into a desired position inside an unpackaging work cell; continuing to move the target container while cutting through the surface of the target container along a closed path that follows on or near the target container's perimeter bottom edge near its sidewalls such that the target container's flat bottom surface is separated from the top and sides, or dome, of the target container; moving the separated dome of the target container, together with its target product still encapsulated inside the dome, out of the unpackaging work cell and to a desired exit point; removing said dome from the target product; disposing of said dome into a desired disposal container; and disposing of said separated bottom surface into a desired disposal container.
